(19) United States
(12) Patent Application Publication
(10) Pub. No.: US 2026/0119151 A1
(43) Pub. Date: Apr. 30, 2026

(54) Firmware Update Over a Serial Bus

(71) Applicant: Mellanox Technologies, Ltd., Yokneam (IL)

(72) Inventors: Joseph Haim, Netanya (IL); Avi Levi, Adi (IL)

(21) Appl. No.: 18/931,159

(22) Filed: Oct. 30, 2024

(51) Int. Cl. G06F 8/65

(52) U.S. Cl. CPC G06F 8/65

(57) ABSTRACT

A computer system includes at least two processors, and a Firmware (FW) update circuit. Each of the processors includes (i) a FW-Store and (ii) a serial-bus interface for communicating over a serial bus. The FW-Update circuit is to load FW code to one or more of the processors over the serial bus.

### TECHNICAL FIELD

The present disclosure relates to firmware updates in a computing system, and, particularly to parallel firmware update of multiple processors in a computing system.

### BACKGROUND

Firmware (FW) update in computer systems typically comprises loading of a new FW code to a FW store (e.g., a Non-Volatile Memory, or NVM) in the computer system. The new FW may be received, for example, over the Internet.

### GENERAL DESCRIPTION

An embodiment that is described herein provides a computer system including at least two processors, and a Firmware (FW) update circuit. Each of the processors includes (i) a FW-Store and (ii) a serial-bus interface for communicating over a serial bus. The FW-Update circuit is to load FW code to one or more of the processors over the serial bus.

Typically, the FW-Update circuit is to load the FW code without an external programmer device. In some embodiments, the FW-Update circuit is to load at least portions of the FW code in parallel to two or more of the processors over the serial bus.

In a disclosed embodiment, the FW-Update circuit is to acquire a processor address of at least one of the processors over the serial bus, and to load the FW code to the respective processor according to the processor address. In another embodiment, the FW-Update circuit is to activate a Boot input of a processor among the processors, thereby causing the processor to run a FW load program that loads the FW code through the serial bus.

In some embodiments, the serial bus includes an Inter-Integrated Circuit (I2C) bus. In other embodiments, the serial bus includes a Serial Processor Interconnect (SPI) bus.

In an embodiment, the processors include interconnect transceivers in a network device. In an example embodiment, the processors are configured as slave devices of the serial bus, and the FW-Update circuit is configured as a master device of the serial bus. In an embodiment, the at least two processors and the FW-Update circuit are embodied in a network switch. In another embodiment, the at least two processors and the FW-Update circuit are embodied in a Network Interface Controller (NIC).

There is additionally provided, in accordance with an embodiment that is described herein, a method including operating at least two processors, each processor including (i) a Firmware (FW)-Store and (ii) a serial-bus interface for communicating over a serial bus. FW code is loaded to one or more of the processors over the serial bus using an FW-Update circuit.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a Communication Computer System that employs FW loading, in accordance with an embodiment that is disclosed herein;

FIG. 2 is a block diagram that schematically illustrates a Communication Computer System with parallel FW loading of multiple Transceiver Processors, in accordance with an embodiment that is disclosed herein;

FIG. 3 is a block diagram that schematically illustrates a 72-processor Communication Computer System that employs FW loading, in accordance with an embodiment that is disclosed herein;

FIG. 4 is a flowchart that schematically illustrates a method for I2C Address Acquisition, in a Communication Computer System, in accordance with an embodiment that is disclosed herein;

FIG. 5 is a flowchart that schematically illustrates a method for FW loading in a Communication Computer System, in accordance with an embodiment that is disclosed herein;

FIGS. 6-8 are block diagrams that schematically illustrates example communication systems that employ firmware update, in accordance with embodiments that are disclosed herein;

FIGS. 9A and 9B illustrate a top view and perspective view, respectively, of a transceiver module operatively coupled to a Network Interface Controller (NIC) that employs firmware update in accordance with an embodiment that is disclosed herein; and

FIG. 10 is a block diagram that schematically illustrates a network device that employs firmware update in accordance with an embodiment that is disclosed herein.

### DETAILED DESCRIPTION OF EMBODIMENTS

### Overview

Computer systems typically comprise a Firmware (FW) code which, for example, governs the system boot sequence and provides basic system functions. The FW is loaded into an FW-store, typically a non-volatile memory (NVM) such as a Flash memory (parts or the full FW code may be copied to main memory, for faster operation).

While the upgrading and changing of computer programs is a common operation, loading of new FW versions (e.g., FW updates) is relatively infrequent, and typically protected by passwords and other security means.

Multi-processor computer systems comprise multiple processors, which comprise multiple FW code copies (the FW codes may be identical or different). FW update of a multi-processor system sometimes includes loading new FW copies to all the processors.

Embodiments that are disclosed herein provide apparatuses and methods that facilitate parallel loading of FW to multiple processors. In an embodiment, the computer system comprises an FW Update Circuit that is configured to connect to multiple processors over multiple ports of a serial bus, such as Inter-Integrated Circuit (I2C). The FW Update Circuit is configured to acquire the I2C addresses of the processors and may load individual FW codes to the various processors, concurrently. To load the FW code of a given processor, the FW Update Circuit first initiates a boot loop using a Reset input (that resets the processor) and a Boot input (that starts a processor boot sequence) of the processor, and then acquires the I2C address of the processor.

The disclosed FW loading schemes enable any on-board or on-chip circuit or device, e.g., a host or a Field-Programmable Gate Array (FPGA), to load FW to multiple processors in parallel, without a need for an external programmer or to a connection to each of the multiple processors.

### System Description

In the description below Communication Computer Systems might comprise Switch or Transceiver Processors (sometimes referred to as Interconnect Transceivers hereinbelow). However, the disclosure below is by no means limited to communication systems and/or to transceiver processors; rather, in embodiments, any suitable computer system that comprises one or more processors may be used. The processors may comprise, for example, processing cores, CPUs, microcontroller units (MCUs) and the like.

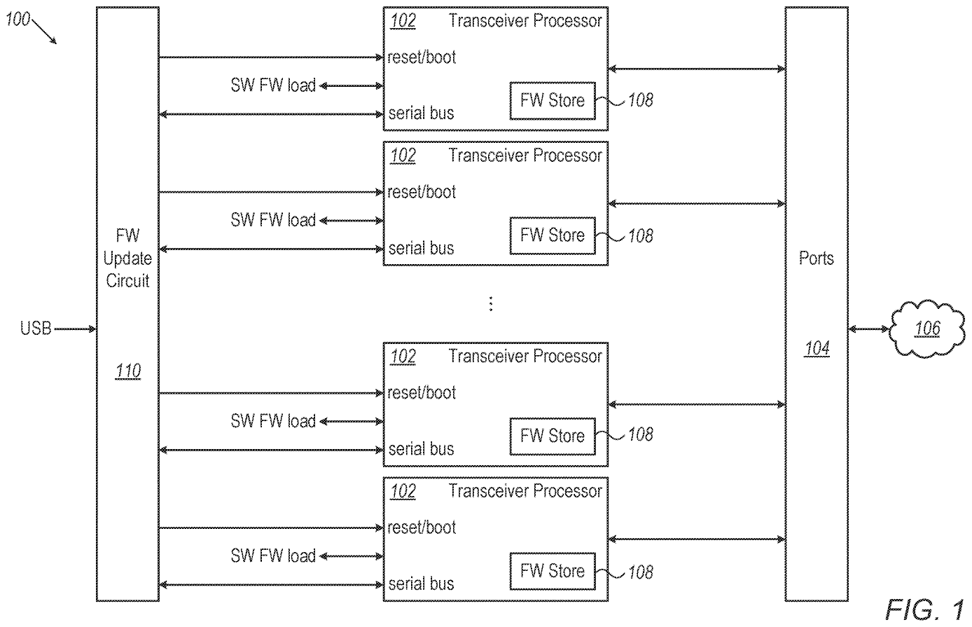

FIG. 1 is a block diagram that schematically illustrates a Communication Computer System 100, in accordance with an embodiment that is disclosed herein. The Communication Computer System comprises a plurality of Transceiver Processors 102, which communicates through Communication Ports 104 to a Network 106. In embodiments, the Ports communicate with the Network over an Ethernet connections, or, in other embodiments, over InfiniBand™.

According to the example embodiment illustrated in FIG. 1, each Transceiver Processor 102 comprises an FW Store 108 that stores the FW of the Transceiver Processor. In some embodiments, the FW-Store comprises a Flash memory.

To facilitate a fast FW load, concurrently to some or to all Transceiver Processors 102, Communication Computer System 100 further comprises an FW-Update Circuit 110, which is configured to receive an FW image from a host computer, for example, through a Universal System Bus (USB) port. The host computer may be, in embodiments, a processor in the Communication Computer System 100 or, in other embodiments, an external host computer. After receiving the FW image, the FW Update Circuit 110 loads the FW codes to the individual Transceiver Processors 102 over a serial bus, such as Inter-Integrated Circuit (I2C) (in embodiments, the Transceiver Processors comprise I2C Slaves, whereas the FW-Update Circuit comprises an I2C Master. In embodiments, the FW-Update Circuit 110 loads at least part of the FW to multiple Transceiver Processors.

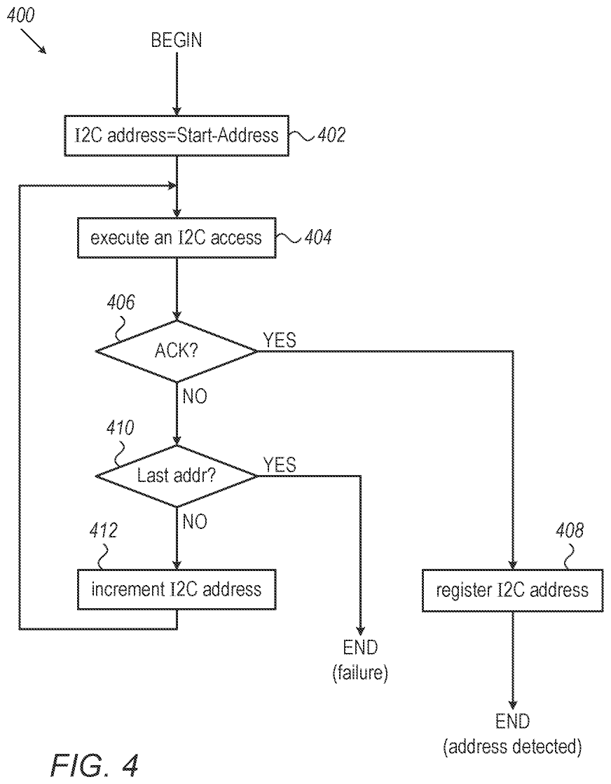

In embodiments, to facilitate FW load, the FW-Update Circuit sends a preset sequence of reset and boot signals to the Transceiver Processors; the sequence of reset and boot signals triggers a loop of Flash-Write operations in the Transceiver Processors. In some embodiments, the FW-Update Circuit, prior to loading the FW codes, identifies the Transceiver Processors, e.g., by acquiring the I2C addresses (we will present an indirect address acquisition method below, with reference to FIG. 4).

According to the example embodiment illustrated in FIG. 1, loading of the Transceiver Processor FW and/or parts thereof can also be done by software. For example, in some embodiments, software programs that run on one of the processors of Communication Computer System 100 may access the Transceiver Processors (e.g., over Peripheral Component Interface Express (PCIe) bus), to load the FW codes or parts thereof.

The configuration of Communication Computer System 100 illustrated in FIG. 1 and described herein above is cited by way of example. Other configurations may be used in alternative embodiments. For example, in an embodiment, the FW Update Circuit loads the FW code into the Transceiver Processors using a parallel bus, such as Advanced Microcontroller Bus Architecture-Advanced High-performance Bus (AMBA-AHB) or Advanced High-performance Bus-Advanced Peripheral Bus (AMBA-APB), or others. In some embodiments, a serial-bus multiplexer is used, to extend the address range of the serial bus.

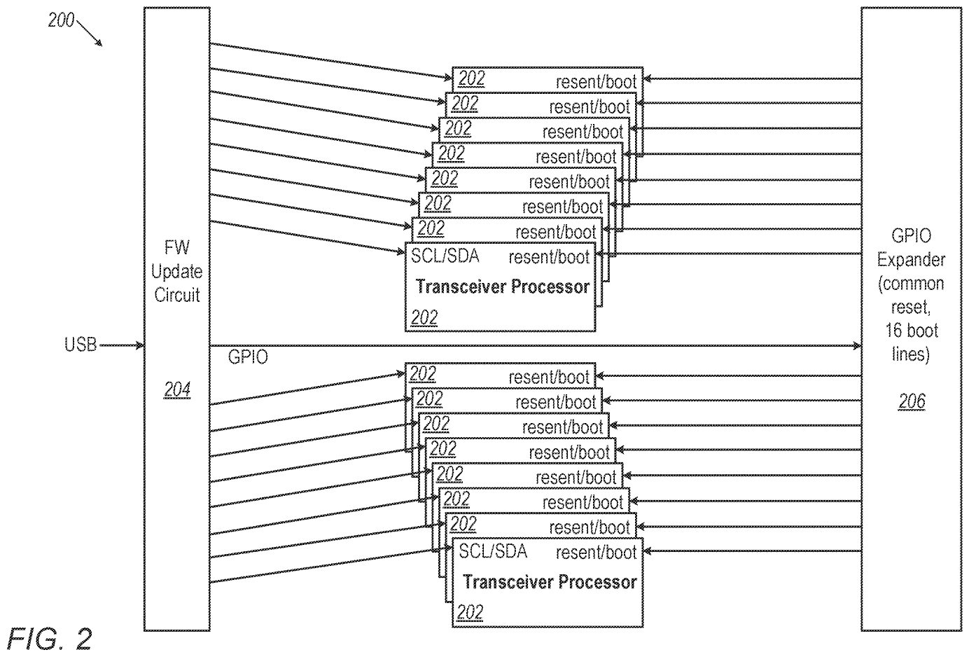

FIG. 2, is a block diagram that schematically illustrates a Communication Computer System 200 with parallel FW loading of multiple Transceiver Processors, in accordance with an embodiment that is disclosed herein. It should be noted that Communication Computer System 200 may comprise additional circuitry, including communication ports, crossbar switches and others, that are not shown in FIG. 2, which, for the sake of conceptual clarity, focuses merely on the FW loading circuitry.

Communication Computer System 200 comprises 16 Transceiver Processors 202 that are configured to execute communication tasks, an FW Update Circuit 204 that is configured to load new FW code into the Transceiver Processors, and a General-Purpose Input-Output (GPIO) Expander 206. The FW Update Circuit 204 is configured to receive new FW images through a USB bus; the FW image may comprise FW codes for multiple Transceiver Processors.

In various embodiments, the FW Update Circuit may be configured to load FW codes to the 16. Transceiver Circuits according to multiple disciplines. For example:
1. The FW image may comprise 16 FW code versions, for the 16 Transceiver Processors.
2. The FW image may comprise a single FW code, which is loaded to selected Transceiver Processors (the non-selected Transceiver Processors will retain their previous FW code).
3. The FW image may comprise a group of n different FW code versions, wherein n is less than 16, and wherein a preset mapping table defines the FW code to be loaded to each of the 16 Transceiver Processors.
4. The FW image may comprise partial FW updates (e.g., update the FW from a start address to an end address).
5. The FW image may comprise a single FW code; the FW Update Circuit modifies the code for each of the Transceiver Processors (e.g., adds a different ID byte in a predefined address).
6. Various combinations of the disciplines mentioned above may be used.

According to the example embodiment illustrated in FIG. 2, the FW Update Circuit comprises an I2C Master, whereas the Transceiver Processors comprise I2C slaves, having respective I2C addresses. The FW Update Circuit loads the FW code into the Transceiver Processors over individual I2C ports of the Transceiver Processors. Each I2C port comprises a Clock input (SCL) wire and a data input/output wire (SDA).

To initiate the FW loading, the FW Update Circuit may need to send a preset sequence of Reset and Boot signals to the Transceiver Processors. According to the example embodiment illustrated in FIG. 2, the FW Update Circuit signals the GPIO Expander 206 to send the sequence of the Boot and the Reset signals. For example, the FW Update Circuit 204 may send address and data signals that indicate logic values that the GPIO Expander should assert on each of the 16 Reset and the 16 Boot inputs of the Transceiver Processors. In an embodiment, the Reset input is common to all 16 Transceiver processors, whereas the Boot lines are individually programmed; the FW Update Circuit may initiate a common Reset to all Transceiver Processors and then activate the Boot input of a subset of the processors.

The configuration of Communication Computer System 200 illustrated in FIG. 2 and described herein above is cited by way of example. Other configurations may be used in alternative embodiments. For example, in embodiments, the number of Transceiver Processors may be different from 16. In an embodiment, the FW Load Circuit receives the FW image over buses other than USB, e.g., PCIe, AMBA-AXI and others. In some embodiments, the FW Load Circuit is external to the Communication Computer System. In embodiments, the FW Load Circuit loads the FW into the Transceiver Circuits over buses other than I2C, e.g., Serial Interface (SPI).

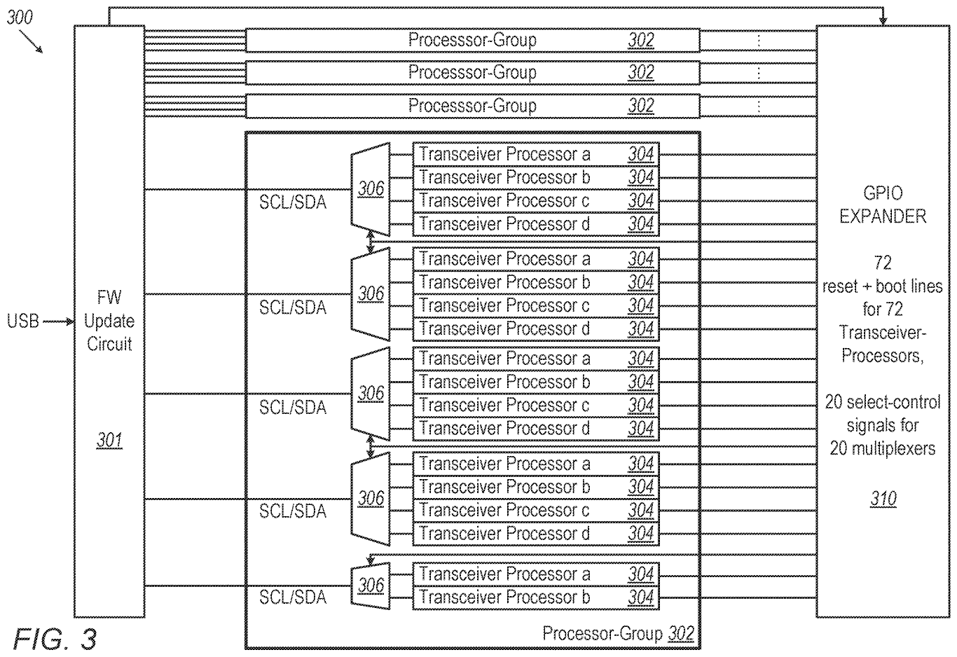

FIG. 3 is a block diagram that schematically illustrates a 72-processor Communication Computer System 300, in accordance with an embodiment that is disclosed herein. Communication Computer System 300 comprises an FW Update Circuit 301, which is loaded with an FW image through a USB port.

The transceiver may be a part of a switch (CPO switch) or a NIC as described above. The switch may comprise multiple switch chips, each one controlling a transceiver. Multiple transceivers may be updated at the same time.

The FW Update Circuit comprises 16 I2C ports and cannot directly load the FW code to more than 16 Transceiver Processors. According to the example embodiment illustrated in FIG. 3, the Transceiver Processors are grouped in four Processor-Groups 302. Each Processor Group comprises eighteen Transceiver Processors 304 and five I2C Multiplexors 306, that are configured to multiplex a single I2C port to four Transceiver Processors each (since the number of Transceiver Processors in a Processor group is 18, or 4*4+2, four of I2C Multiplexers 306 multiplex the I2C ports of four Transceiver Processors each, while a fifth I2C Multiplexer multiplexes the I2C ports of two Transceiver-Processors). The Transceiver Processors that are connected to inputs of the I2C Multiplexers are designated a, b, c and d (or a and b for the Transceiver Processors that are connected to the two-input I2C Multiplexer).

A GPIO Expander 310 is configured to drive the Reset and Boot inputs of the 72 Transceiver Processors (as explained above, with reference to FIG. 2), and, to control the twenty I2C Multiplexers 306.

Thus, the FW Update Circuit 308 can update the FW of all 72 Transceiver Processors in four separate FW update runs, changing the setting of I2C multiplexers 306 between the runs and updating the FW of up to 18 Transceiver-Processors in each run.

FW update order may be, for example, the following:
1. The FW Update Circuit 308 controls the GPIO Expander 310 to set a Reset signal of all 72 Transceiver Processors.
2. The FW Update Circuit controls the GPIO Expander to set all 20 I2C Multiplexers 304 to select the “a” input.
3. The FW Update Circuit controls the GPIO Expander to send a Boot signal to all “a”-designated Transceiver Processors.
4. The FW Update Circuit 308 controls the GPIO Expander 310 to reset a Reset signal to all 72 Transceiver Processors, (this will initiate a Boot sequence in the “a” designated Transceiver Processors).
5. The FW Update Circuit loads the FW code to all 20 Transceiver Processors that are designated “a”, in the four Processor Groups.
6. The FW Update Circuit repeats steps 3, 4 and 5 for all 20 Transceiver Processors that are designated “b”.
7. The FW Update Circuit repeats steps 3,4 and 5 for all 16 Transceiver Processors that are designated “c”.
8. The FW Update Circuit repeats steps 3, 4 and 5 for all 16 Transceiver Processors that are designated “d”.

The configuration of 72-processor Communication Computer System 300 illustrated in FIG. 3 and described herein above is cited by way of example. Other configurations may be used in alternative embodiments. For example, in some embodiments, the GPIO Expander 310 is configured via an AMBA APB bus. In other embodiments, a single I2C bus may be shared by more than one Transceiver Processors, decreasing the number of I2C multiplexers on one hand but, on the other hand, degrading parallelism, as the FW Update Circuit will load the FW code to Transceiver Processors that share an I2C bus in a serial manner.

### I2C Address Acquisition

In some embodiments, the FW code to be loaded to each Transceiver Processor is determined according to the I2C port of the FW Update Circuit to which the Transceiver Processor is connected. For example, a Transceiver Processor that is connected to a first slot of a mother PCB may receive a first FW version, while another Transceiver Processor, connected to a second slot, gets a second FW version. The mapping between I2C ports and I2C addresses, however, may not be known.

In embodiments, the loading of the FW code to a Transceiver Processor is preceded by an address acquisition operation, wherein the FW Update Circuit writes or reads each of the Transceiver Processors, with increasing I2C addresses, from a first address to a last address (in embodiments, to avoid special I2C addresses, the first possible address is 0b0001000 and the last possible address is 0b1110111). If the Transceiver Processor acknowledges the access (sending an Acknowledge is part of the I2C protocol), the FW Update Circuit will store the mapping of the I2C port to the address.

FIG. 4 is a flowchart 400 that schematically illustrates a method for I2C Address Acquisition, in a Communication Computer System, in accordance with an embodiment that is disclosed herein. The flowchart is executed by FW Load Circuit 110 (FIG. 1), for each of the Transceiver Processors (in some embodiments, the FW Load Circuit may execute the flowchart concurrently for more than one Transceiver Processor, over more than one respective I2C ports).

The flowchart begins at a Set-Address-to-First operation 402, wherein the FW Update Circuit sets an I2C a preset First Address; in an Address parameter to embodiment, the first I2C address is 0b0010000, skipping the predefined special addresses of the I2C.

Next, at an Execute-I2C-Access operation 404, the FW Update Circuit executes a Read access to the Transceiver Processor, with the Address field according to the I2C address parameter.

The FW Update Circuit then, at a Check-ACK operation 406, checks if the Transceiver Processor returns an ACK bit to acknowledge the access. If so, the FW Update Circuit, at a Register I2C Address operation 408, writes the I2C address in a mapping table (that maps I2C ports of the FW Update Circuit to I2C addresses of the respective Transceiver Processors), and ends the flowchart.

If, at Check-ACK operation 406, the Transceiver Processor does not acknowledge the access (e.g., the Transceiver Processor sends a NACK bit), the FW Update Circuit enters a Check-Last operation 410 and checks whether the current I2C address value equals a predefined Last Address (e.g., 0b1110111). If so, the I2C address has not been detected, and the flowchart ends. If, in Check-Last operation 410, the IC address is less than the predefined Last address, the FW Update Circuit enters an Increment-Address operation 412, increments the I2C Address parameter, and then reenters operation 404, to check the next I2C address.

The configuration of I2C Address Acquisition flowchart 400 illustrated in FIG. 4 and described herein above is cited by way of example. Other configurations may be used in alternative embodiments. For example, in some embodiments, a 10-address-bit I2C is used. In an embodiment, the addresses are scanned down, starting with the highest possible address and ending with the lowest address.

### Methods

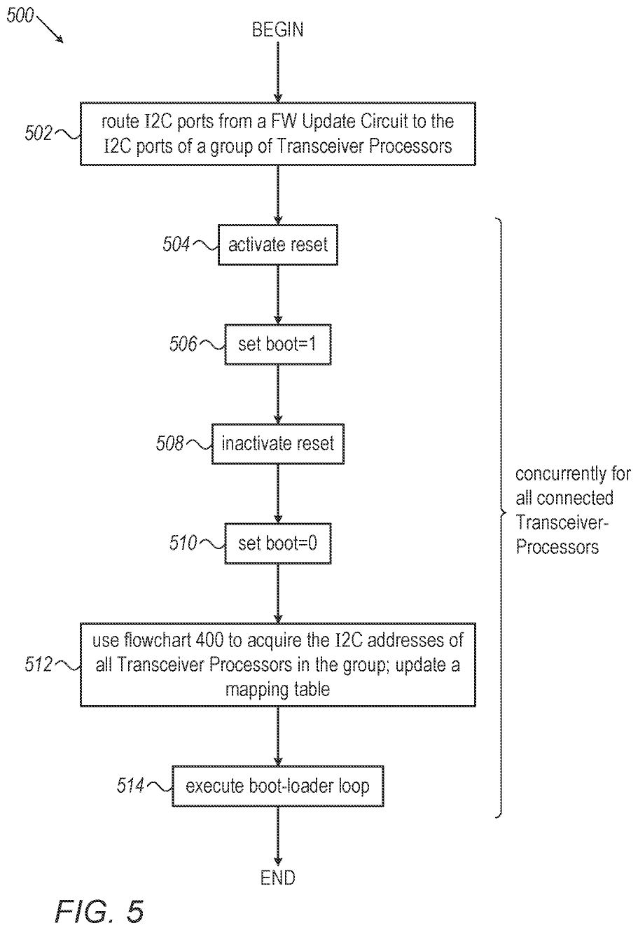

FIG. 5 is a flowchart 500 that schematically illustrates a method for FW loading in a Communication Computer System, in accordance with an embodiment that is disclosed herein. The flowchart is executed by FW Update Circuit 301, GPIO Expander 310 and I2C Multiplexers 306 (FIG. 3).

The flowchart begins at a Route-I2C-Ports operation 502, wherein the FW Update Circuit routes some of the I2C ports of the FW Update Circuit, using the GPIO Expander and the I2C Multiplexers, to a group of Transceiver Processors. Next, FW Update Circuit enters an Activate Reset operation 504, followed by a Set-Boot-1 operation 506, an Inactivate-Reset Operation 508 and a Set-Boot-0 operation 510, wherein The FW Update Circuit 301, through the GPIO Expander 310, sequentially activates the Reset input of the Transceiver Processor, sets the Boot input of the Transceiver Processor to logic-high, inactivates the Reset input and then sets the Boot input to Logic low. This sequence (or, rather, the first three operations thereof) will cause the Transceiver Processor to receive the FW code through the I2C port.

Next, at an Acquire I2C Addresses operation 512, the FW Update Circuit acquires the I2C addresses of Transceiver Processors that are connected to the I2C ports (for example, using the method of flowchart 400, FIG. 4).

At this point, the FW Update Circuit can load FW codes to individual Transceiver Processors, according to a mapping table the matches I2C ports to I2C addresses. The

Lastly, at an Execute-Boot-Loader-Loop operation 514, the FW Update Loader will start an FW-load loop and load the FW into the Transceiver Processor.

It should be noted that operations 506 through 514 may be executed in parallel for all connected Transceiver Processors (for example, according to the example embodiment illustrated in FIG. 3, FW Update Loader 301 will execute operations 506 through 514 in parallel to groups of 20 and 18 Transceiver-Processors.

The configuration of flowchart 500, illustrated in FIG. 5 and described herein above is cited by way of example. Other configurations may be used in alternative embodiments. For example, in an embodiment, the Transceiver-Processors load a new FW code in response to an I2C Write operation with a preset data value. In some embodiments, the number of Transceiver Processors is less than or equal to the number of the FW Load Circuit I2C ports, and, hence, operation 504 is not needed.

### Communication Systems

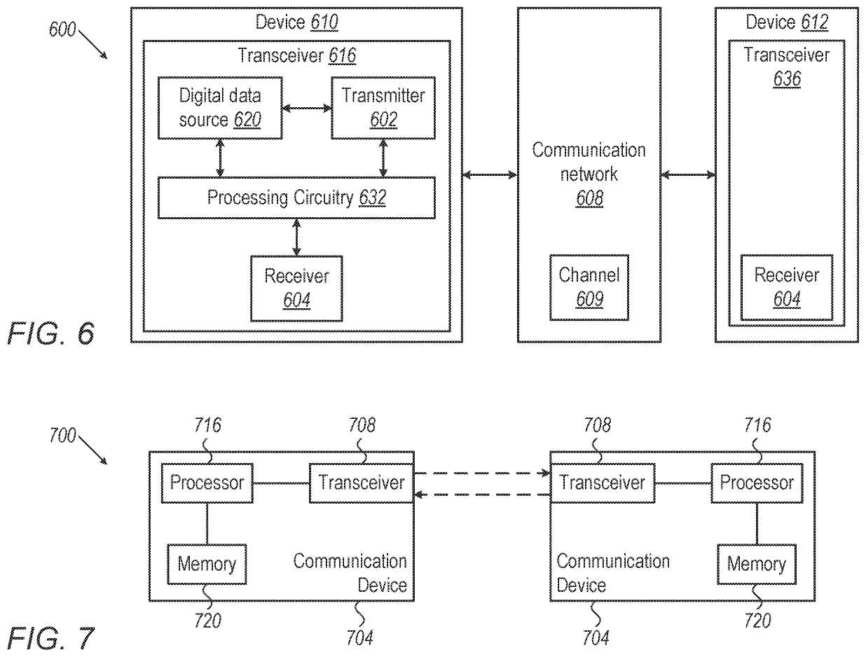

FIG. 6 illustrates an example communication system 600 according to at least one example embodiment. The system 600 includes a device 610, a communication network 608 including a communication channel 609, and a device 612. In at least one embodiment, devices 610 and 612 are two end-point devices in a computing system, such as a central processing unit (CPU) or graphics processing unit (GPU).

In at least one embodiment, devices 610 and 612 are two servers. In at least one example embodiment, devices 610 and 612 correspond to one or more of a Personal Computer (PC), a laptop, a tablet, a smartphone, a server, a collection of servers, or the like. In some embodiments, the devices 610 and 612 may correspond to any appropriate type of device that communicates with other devices connected to a common type of communication network 108.

According to embodiments, the receiver 604 of devices 610 or 612 may correspond to a GPU, a switch (e.g., a high-speed network switch), a network adapter, a CPU, a memory device, an input/output (I/O) device, other peripheral devices or components on a system-on-chip (SoC), or other devices and components at which a signal is received or measured, etc. As another specific but non-limiting example, the devices 610 and 612 may correspond to servers offering information resources, services, and/or applications to user devices, client devices, or other hosts in the system 600.

In one example, devices 610 and 612 may correspond to network devices such as switches, network adapters, or data processing units (DPUs). The device 610 includes a transceiver 616 for sending and receiving signals, for example, data signals. The data signals may be digital or optical signals modulated with data or other suitable signals for carrying data.

The transceiver 616 may include a digital data source 620, a transmitter 602, a receiver 604, and processing circuitry 632 that controls the transceiver 616. The digital data source 620 may include suitable hardware and/or software for outputting data in a digital format (e.g., in binary code and/or thermometer code). The digital data output by the digital data source 620 may be retrieved from memory (not illustrated) or generated according to input (e.g., user input).

The transmitter 624 includes suitable software and/or hardware for receiving digital data from the digital data source 620 and outputting data signals according to the digital data for transmission over the communication network 608 to a receiver 604 of device 612.

The receiver 604 of devices 610 and 612 may include suitable hardware and/or software for receiving signals, such as data signals from the communication network 608. For example, the receiver 604 may include components for receiving optical signals.

The processing circuitry 632 may comprise software, hardware, or a combination thereof. For example, the processing circuitry 132 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory).

Additionally, or alternatively, the processing circuitry 632 comprise may hardware, such as an application-specific integrated circuit (ASIC). Other non-limiting examples of the processing circuitry 632 include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like.

Some or all of the processing circuitry 632 may be provided on a Printed Circuit Board (PCB) or collection of PCBs. It should be appreciated that any appropriate type of electrical component or collection of electrical components may be suitable for inclusion in the processing circuitry 632. The processing circuitry 632 may send and/or receive signals to and/or from other elements of the transceiver 616 to control the overall operation of the transceiver.

In embodiments, each of devices 610 and 612 may comprise one or more processing circuits, as detailed above; the processing circuits may comprise FW, that is loaded according to the techniques described above.

FIG. 7 is a block diagram that schematically illustrates a communication system 700, in accordance with an embodiment that is disclosed herein. The Communication system 700 comprises two communication devices 704 that are configured to exchange electronic communications (e.g., packet-based communications) with one another over a communication channel 712. The communication channel 712 may include or be part of a communication network.

Illustratively, but without limitation, the communication devices 704 may correspond to network devices. As such, the communication devices 704 may correspond to any type of device that becomes part of or is connected with a communication network. Examples of suitable devices that may act or operate like a communication device 704 as described herein include, without limitation, one or more of a Personal Computer (PC), a laptop, a tablet, a smartphone, a server, a collection of servers, a networking card, an edge router, a switch, Network Interface Cards, a Top of Rack (ToR) switch, a server blade, or the like. As will be described in further detail herein, the communication device 704 may include a transceiver 708, a processor 716, and memory 720. The transceiver 708 may include hardware that enables communications over the communication channel 712 whereas the processor 716 and memory 720 may include components that enable the communication device 704 to provide a desired functionality or perform certain functions.

The communication channel 712 may traverse a datacenter or any type of communication network (whether trusted or untrusted). Examples of a communication network that may be used to connect communication devices 704 and support the communication channel 712 include, without limitation, an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network enables data transmission between the communication devices 704 using optical signals. In this case, the communication devices 704 and the communication network may include waveguides (e.g., optical fibers) that carry the optical signals.

The transceiver 708 may include electrical components, optical components, or combinations thereof that facilitate communications over the communication channel 712. The components of the transceiver 708 may be coupled to the processor 716. Data, electrical signals, or the like may be exchanged between the transceiver 708 and processor 716. In some embodiments, the processor 716 may utilize the transceiver 708 to transmit data packets to a remote communication device 704 via the communication channel 712. Similarly, data packets received at a transceiver 708 may be decoded by the transceiver 708 and provided to the processor 716 coupled therewith. In some embodiments, the processor 716 may utilize instructions stored in memory 720 to facilitate operations of the communication device 704.

The processor 716 may be or include one or more of an Integrated Circuit (IC) chip, a microprocessor, a Central Processing Unit (CPU), a Graphics Processing Unit (GPU), a Data Processing Unit (DPU), a Field Programmable Gate Array (FPGA), an Application Specific Integrated Circuit (ASIC), combinations thereof, and the like.

The memory 720 may include any number of memory devices, any type of memory device, any combination of different types of memory devices, etc. As an example, the memory 720 may include Random Access Memory (RAM), Read Only Memory (ROM), flash memory, Electronically-Erasable Programmable ROM (EEPROM), Dynamic RAM (DRAM), buffer memory, combinations thereof, and the like.

In embodiments, each of communication devices 704 may comprise one or more processing circuits, as detailed above; the processing circuits may comprise FW, that is loaded according to the techniques described above.

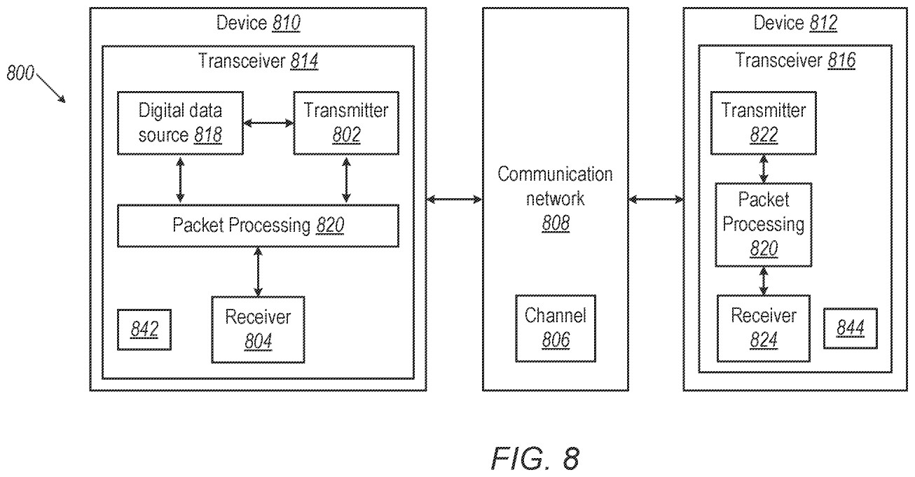

FIG. 8 is a block diagram that schematically illustrates a Communication System 800, in accordance with an embodiment that is disclosed herein. Communication System 800 comprises a device 810, a communication network 808, a communication channel 806, and a device 812. In at least one embodiment, the devices 810 and 812 are integrated circuits of a Personal Computer (PC), a laptop, a tablet, a smartphone, a server, a collection of servers, or the like.

In some embodiments, the devices 810 and 812 may correspond to any appropriate type of device that communicates with other devices also connected to a common type of communication network 808.

In embodiments, the transmitters 802 and 822 of devices 810 and 812 may correspond to transmitters of a graphics processing unit (GPU), a switch (e.g., a high-speed network switch), a network adapter, a central processing unit (CPU), a data processing unit (DPU), etc.

In embodiments, each of communication devices 810 and 812 may comprise one or more processing circuits, as detailed above; the processing circuits may comprise FW, that is loaded according to the techniques described above.

### Transceiver Module

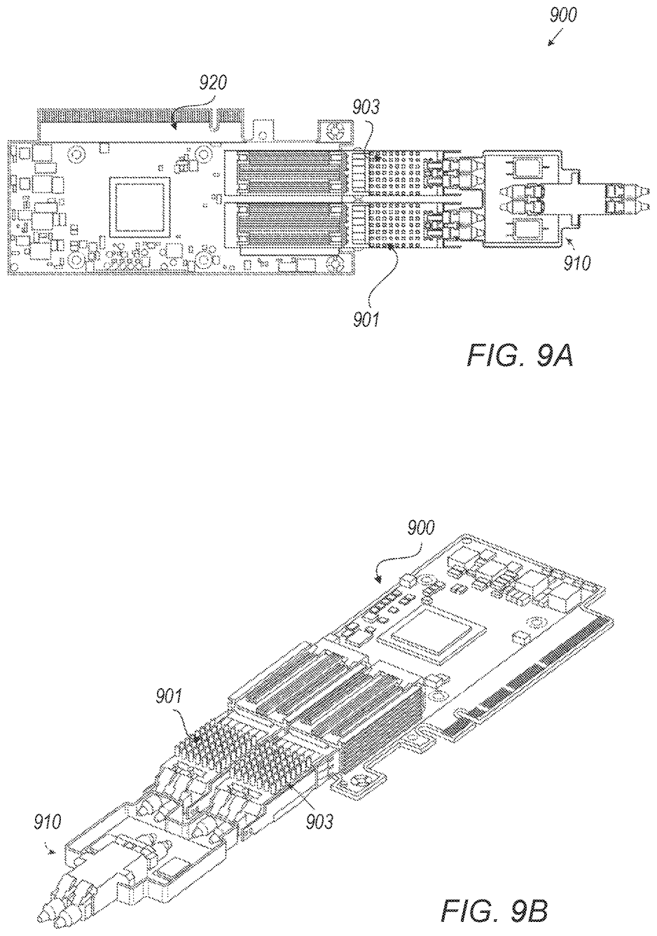

FIGS. 9A and 9B illustrate a top view and a perspective view, respectively, of a transceiver module operatively coupled to a network adapter, in the present example a Network Interface Controller (NIC) 900, in accordance with an embodiment of the invention. As shown in FIGS. 9A and 9B, the transceiver module may include a first optical module 901, a second optical module 903, an adapter 910, and a dual-port NIC 920 of a server. Both the first optical module 901 and the second optical module 903 may be dual-fiber transceivers that are configured for duplex communication that allows the source (e.g., server) to communicate with the target (e.g., leaf switch) in both directions. The adapter 910 may be a ganged physical component configured to link the first optical module 901 and the second optical module 903 for the purpose of transmitting and receiving data to and from the leaf switch.

In some embodiments, the adapter 910 may be configured to operate in two configurations, such as a first configuration and a second configuration. In one aspect, the first configuration may be a default configuration of operation, where the first optical module 901 may be operationally active. The second configuration may be a contingent configuration that is implemented when the first optical module 901 operationally fails. When such a failure is detected, the second optical module 903, which is otherwise operationally inactive or idle, may be engaged become operationally active and handle all network traffic that was initially handled by the first optical module 901. In some embodiments, the transceiver module 900 may be configured to operate in a leaf-spine architecture. A leaf-spine architecture is a data center network topology that may include two switching layers-a spine layer and a leaf layer. The leaf layer may include access switches (leaf switches) that aggregate traffic from servers and connect directly into the spine or network core. Spine switches interconnect all leaf switches in a full-mesh topology between access switches in the leaf layer and the servers from which the access switches aggregate traffic. As such, in one embodiment, to ensure reliable operation of downlinks, the transceiver module 900 may be configured to operate between the server and the leaf layer. In particular, as shown in FIGS. 9A and 9B, the adapter 910 may be operatively coupled to the first optical module 901 and the second optical module 903, while the first optical module 901 and the second optical module 903 may be operatively coupled to a dual-port NIC 920 of a server.

In embodiments, NIC 900 may comprise one or more processing circuits, as detailed above; the processing circuits may comprise FW, that is loaded according to the techniques described above.

### Optical Switch Assemblies

High-capacity optical switch assemblies switch multiple channels of data at high data rates, with the number of channels reaching several hundreds and data rates reaching hundreds of Gb/s (Gb/s=109 bits per second). In order to save power, it is desirable to co-package the switch itself with “optical engines,” which typically are small, high-density optical transceivers located within an application-specific integrated circuit (ASIC) or within an ASIC package together with the switch.

The switch assembly is contained in a rack-mounted case, with optical receptacles on its front panel for ease of access. The signals from and to the ASIC are conveyed to and from the optical receptacles using optical fibers. Space constraints of the switch and the front panel limit the number of optical fibers connected to the ASIC and optical receptacles on the panel. Therefore, the optical signals emitted and received by the switch are multiplexed using wavelength-division multiplexing, so that each fiber, along with the associated optical receptacle, carries multiple optical signals. For example, each fiber may carry four channels of 100 Gb/s each, at four different, respective wavelengths, to and from the corresponding optical receptacle, for a total data rate of 400 Gb/s (denoted as 4×100 Gb/s).

In many cases, the multiple communication channels carried at different wavelengths on the same fiber are directed to and from different network nodes. For example, each of the 100 Gb/s component signals on a 4×100 Gb/s optical link may be directed to a different server. Therefore, there is a need for an optical cable that is capable of splitting the multiplexed optical signal into multiple component signals at different, respective wavelengths, and be capable of conveying each of these signals to a different network node. For simplicity of installation and use, it is desirable that the optical cable be “active,” meaning that transceivers in the cable convert each of the multiple optical signals to a standard electrical form (and vice versa). As a result, the network nodes need process only electrical signals and will be indifferent to the actual wavelength of the optical channel that is directed to each of them.

To further simplify installation and use, it is sometimes desirable that the optical cable be detachable from the transceivers so that a smaller cable may be routed through an installation. Each optical cable may, instead of comprising a transceiver, be designed to mate with a particular transceiver. The transceiver may be connected to a node, such as a server, and be used to connect a connector of each cable to the node as described herein. In embodiments, the optical switch assembly may comprise one or more processing circuits; the processing circuits may comprise FW, that is loaded according to the techniques described above.

### Multichip-Module (MCM) Assembly

Co-packaging may refer to the close integration of different electrical and/or optoelectronic chips in the same package.

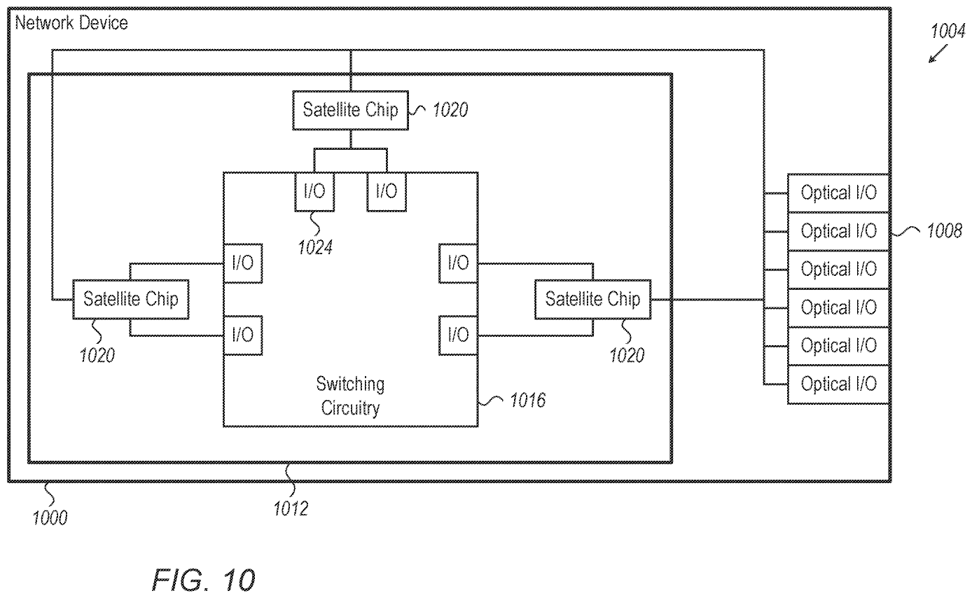

FIG. 10 is a block diagram that schematically illustrates a co-packaged Networking Device 1000, in accordance with an embodiment that is disclosed herein. The different chips that constitute a co-packaged Networking Device are assembled on a single substrate in what is typically called the MCM assembly 1012. The MCM assembly 1012 can include a switching circuitry 1016 surrounded by peripheral or satellite chips 1020. In some embodiments, the switching circuitry 1016 and surrounding satellite chips 1020 are all mounted on a common substrate, although such a configuration is not required. The MCM assembly 1012 may be provided in a larger housing of the networking device 112, positioned behind the front panel 1004. The switching circuitry 1016 may include one or more core digital Application Specific Integrated Circuits (ASICS), CPUS, GPUs, microprocessors, FPGAS, combinations thereof, and the like. The switching circuitry 1016 may include a number of input ports and/or output ports 1028. The Input/Output (I/O) ports 1024 may include electrical ports and/or optical ports. Additionally, the switching circuitry 1016 may include a combination of electrical blocks and optical blocks. The electrical blocks of the switching circuitry 1016 may include a number of electrical switches that are configured to route signals in an electrical domain. The optical blocks of the switching circuitry 1016 may include a number of optical components that are configured to generate, detect and route signals in an optical domain. The MCM assembly 1012, in some embodiments, may concern or include multiple satellite chips 1020 that are assembled on the same substrate as the switching circuitry 1016. In some embodiments, a configuration of the optical block(s) and a configuration of the electrical block(s) depends (e.g., is based on) on the number of optical ports in the I/O ports 1024.

As discussed above, optical I/Os 1008, which may also be referred to as optical connectors, are placed at the front panel 1004. As mentioned above, connectivity between the MCM assembly 1012 and optical I/Os 1008 may be transferred to the front panel 1004 through optical fibers. This connection may be made directly with an optical I/O 1024 of the switching circuitry or may be made with one or more of the satellite chips 1020. The connection is often made with one or more of the satellite chips 1020 because the satellite chips 1020 may include the electro-optic converters and, possibly, the SERDES to natively support the connection. The satellite chips 1020 may include one or more of aDSP processor, driver, trans-impedance amplifier, laser, modulator, photodiode, serializer-deserializer, or the like.

In embodiments, the MCM assembly 1012 may comprise one or more processing circuits; the processing circuits may comprise FW, that is loaded according to the techniques described above.

The configurations of Communication Computers 100, 200 300, communication systems 600, 700, 800, NIC 900, co-packaged Networking Device 1000 and the methods of flowcharts 400 and 500, illustrated in FIGS. 1 through 10 and described hereinabove, are example configurations and methods that are shown purely for the sake of conceptual clarity. Any other suitable configurations and methods can be used in alternative embodiments. The different elements of Communication Computers 100, 200, 300, including FW Update Circuit 110, 204, 301, Device 610, Device 612, Processor 716, Device 810, Device 812, NIC 900, co-packaged Networking Device 1000 and any components thereof may be implemented in an integrated circuit, such as an application specific integrated circuit (ASIC) or a field-programmable gate-array (FPGA). Alternatively, some elements of FW Update Circuits 110, 204, 301 may be implemented in software, or in combination of software and hardware elements.

In some embodiments, Transceiver Processor 102, 202, 304, processing circuitry 632, processor 716 and/or packet processor 820 comprise a general-purpose processor, which is programmed in software and/or in FW to carry out the functions described herein. The software may be downloaded to the processor in electronic form, over a network or from a host, for example, or it may, alternatively or additionally, be provided and/or stored in a non-transitory tangible media, such as magnetic, optical or electronic memory.

Although the embodiments described herein mainly address Firmware Load of processors in a multiprocessor computer system, the methods and devices described herein can also be used in other applications.

It will thus be appreciated that the embodiments described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art.

1. A computer system, comprising:
at least two processors, each processor comprising (i) a Firmware (FW)-Store and (ii) a serial-bus interface for communicating over a serial bus; and
an FW-Update circuit, to load FW code to one or more of the processors over the serial bus.

2. The computer system according to claim 1, wherein the FW-Update circuit is to load the FW code without an external programmer device.

3. The computer system according to claim 1, wherein the FW-Update circuit is to load at least portions of the FW code in parallel to two or more of the processors over the serial bus.

4. The computer system according to claim 1, wherein the FW-Update circuit is to acquire a processor address of at least one of the processors over the serial bus, and to load the FW code to the respective processor according to the processor address.

5. The computer system according to claim 1, wherein the FW-Update circuit is to activate a Boot input of a processor among the processors, thereby causing the processor to run a FW load program that loads the FW code through the serial bus.

6. The computer system according to claim 1, wherein the serial bus comprises an Inter-Integrated Circuit (I2C) bus.

7. The computer system according to claim 1, wherein the serial bus comprises a Serial Processor Interconnect (SPI) bus.

8. The computer system according to claim 1, wherein the processors comprise interconnect transceivers in a network device.

9. The computer system according to claim 1, wherein the processors are configured as slave devices of the serial bus, and the FW-Update circuit is configured as a master device of the serial bus.

10. The computer system according to claim 1, wherein the at least two processors and the FW-Update circuit are embodied in a network switch.

11. The computer system according to claim 1, wherein the at least two processors and the FW-Update circuit are embodied in a Network Interface Controller (NIC).

12. A method, comprising:
operating at least two processors, each processor comprising (i) a Firmware (FW)-Store and (ii) a serial-bus interface for communicating over a serial bus; and
using an FW-Update circuit, loading FW code to one or more of the processors over the serial bus.

13. The method according to claim 12, wherein loading the FW code is performed without an external programmer device.

14. The method according to claim 12, wherein loading the FW code comprises loading at least portions of the FW code in parallel to two or more of the processors over the serial bus.

15. The method according to claim 12, wherein loading the FW code comprises acquiring a processor address of at least one of the processors over the serial bus, and loading the FW code to the respective processor according to the processor address.

16. The method according to claim 12, wherein loading the FW code comprises activating a Boot input of a processor among the processors, thereby causing the processor to run a FW load program that loads the FW code through the serial bus.

17. The method according to claim 12, wherein the serial bus comprises an Inter-Integrated Circuit (I2C) bus.

18. The computer system according to claim 12, wherein the serial bus comprises a Serial Processor Interconnect (SPI) bus.

19. The method according to claim 12, wherein the processors comprise interconnect transceivers in a network device.

20. The method according to claim 12, wherein the processors are configured as slave devices of the serial bus, and the FW-Update circuit is configured as a master device of the serial bus.
